(19) United States
(12) Patent Application Publication
(10) Pub. No.: US 2002/0118644 A1
(43) Pub. Date: Aug. 29, 2002

(54) Method and system to implement policy-based network traffic management

(76) Inventor: Ian Moir, Upper Basildon (GB)

Correspondence Address: Andre L. Marais, BLAKELY, SOKOLOFF, TAYLOR & ZAFMAN LLP, 12400 Wilshire Boulevard, Seventh Floor, Los Angeles, CA, 90025-1026, US

(21) Appl. No.: 09/945,445

(22) Filed: Aug. 31, 2001

Related U.S. Application Data
(60) Provisional application No. 60/230,532, filed on Sep. 1, 2000.

(51) Int. Cl. H04L 1/00

(52) U.S. Cl. 370/230.1

(57) ABSTRACT

A method to implement policy-based network traffic management includes receiving data pertaining to a network device at a network traffic manager, the first data being received out-of-band of network traffic. Second data is extracted from the network traffic. A network traffic management policy is implemented at the network traffic manager utilizing the first and second data.

### CROSS REFERENCE TO RELATED APPLICATIONS

This application claims the benefit of U.S. Provisional Application No. 60/230,532, filed Sep. 1, 2000.

### FIELD OF THE INVENTION

The present invention relates to the field of network traffic management and, more specifically, to implementing policy-based network traffic management based upon rules.

### BACKGROUND OF THE INVENTION

In today's highly networked environment, it has become desirable to offer varying levels of service (e.g., Quality-of-Service (QoS)) to various network entities. For example, where multiple network devices (e.g., web stations, personal computers, set-top boxes, etc.) are coupled to a network via a network connection device (e.g., a router, switch or bridge), the ability to provide differentiated QoS to such network devices may be motivated by a number of factors, including a network operator's commercial objectives.

Environments in which a network manager may wish to provide differentiated QoS include an office environment in which multiple users may access a single connection and, more pertinently, where remote offices of an enterprise share network resources. A further environment in which QoS differentiation may be particularly desirable is within a Multi-Tenant Unit (MTU) (e.g., a high-rise apartment complex or condominium development) where multiple users share a single network connection.

Further, within a business or MTU environment, service level agreements may be in place between end users and a network service provider that guarantee certain performance levels.

The need to provide such differentiated services has become increasingly apparent as the latest generation of copper-based Digital Subscriber Line (DSL) transmission technologies have provided the opportunity to deliver multi-megabit performance cost effectively to a MTU, remote office, kiosk, utility or retail location.

### SUMMARY OF THE INVENTION

A method to implement policy-based network traffic management includes receiving data pertaining to a network device at a network traffic manager, the first data being received out-of-band of network traffic. Second data is extracted from the network traffic. A network traffic management policy is implemented at the network traffic manager utilizing the first and second data.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating, at a high level, the operation of a network traffic manager, according to an exemplary embodiment of the present invention, in the exemplary form of a virtual machine.

FIG. 2 is a block diagram illustrating an exemplary deployment of a network connection device including the virtual machine that accesses a set of classification rules utilized to make traffic classification decisions.

FIG. 3 is a block diagram providing further details of the architecture of an exemplary network traffic manager in the form of a virtual machine.

FIG. 4 is a block diagram providing a conceptual depiction of the utilization of a packet signature, extracted from an incoming packet, to identify a policy to be applied with respect to the packet.

FIG. 5 is a block diagram providing further details regarding the policy table, according to an exemplary embodiment of the present invention.

FIG. 6 is a flow chart depicting a reciprocal flow, where transactions 2 and 3 occur as a direct consequence of transaction 1.

FIG. 7 illustrates the mapping of an ATM physical layer.

FIG. 8 is a flow chart illustrating a method, according to an exemplary embodiment of the present invention, of implementing policy-based network traffic management.

FIG. 9 is a block diagram providing a high level diagrammatic representation of the operation of a virtual machine compiler, according to an exemplary embodiment of the present invention.

FIG. 10 is a block diagram illustrating a rule program as conceptually comprising a number of rules that are utilized to bind process behavior definitions, conveniently labeled operations, to contextual zed sets of data, conveniently labeled registers.

FIG. 11 is a flow chart illustrating a method, according to an exemplary embodiment of the present invention, to pre-compile configuration information for a network connection device.

FIG. 12 is a diagrammatic representation of an exemplary deployment scenario in which a VNIC client application is hosted on each of workstations coupled to a network connection device via a local area network (LAN) 104.

FIG. 13 diagrammatically represents classification rules utilizing both a signature received from a packet and time of day information.

FIG. 14 is a diagrammatic illustration of the communication of the VNIC packets, from a VNIC client application, for contribution to an information profile.

FIG. 15 is a block diagram illustrating replication of a registry 113 in each workstation 102 or, in an alternative embodiment, management of a registry from a domain server.

FIG. 16 diagrammatically illustrates the communication of VNIC packets, utilizing a VNIC protocol during a VNIC session, to establish and contribute to information profiles utilized by a classification rule, in the exemplary form of a bandwidth partitioning classification rule.

FIG. 17 is a diagrammatic representation of a machine in the exemplary form of computer system within which software, in the form of a series of machine-readable instructions, for performing any one of the methods discussed above may be executed.

### DETAILED DESCRIPTION

A method and system to implement policy-based network traffic management are described. In the following description, for purposes of explanation, numerous specific details are set forth in order to provide a thorough understanding of the present invention. It will be evident, however, to one skilled in the art that the present invention may be practiced without these specific details.

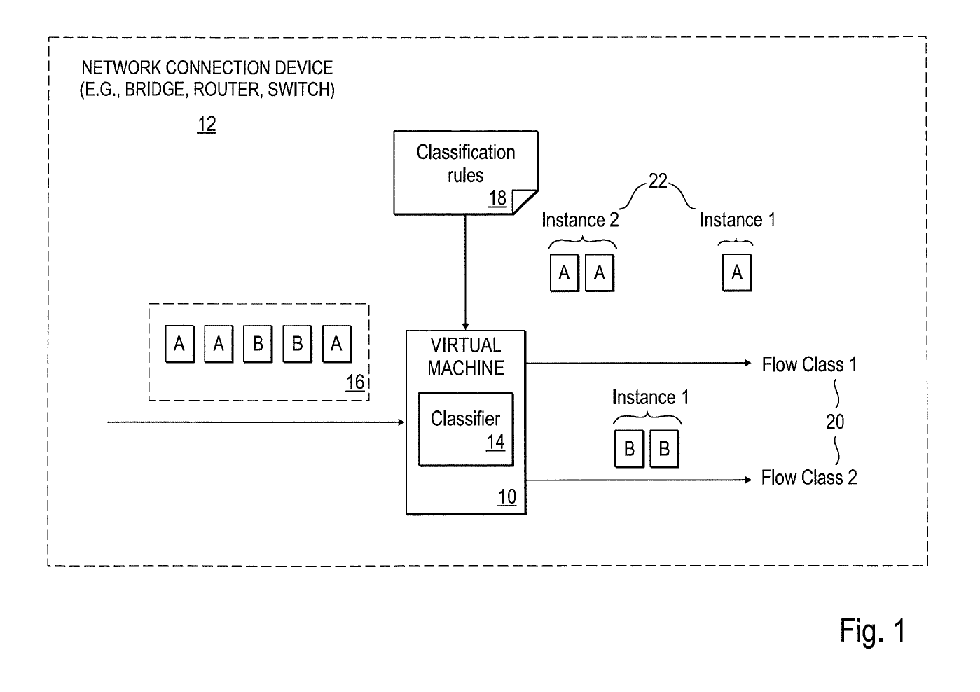

FIG. 1 is a block diagram illustrating, at a high level, the operation of a network traffic manager, according to an exemplary embodiment of the present invention, in the exemplary form of a virtual machine 10. Specifically, FIG. 1 illustrates the virtual machine 10 has been hosted on a network connection (or data communications) device 12 (e.g., a bridge, switch or router). The virtual machine 10 is shown to include a classifier 14 that classifies incoming network traffic 16 in accordance with a set of classification rules 18 provided by a network owner. Specifically, each packet within the incoming network traffic 16 is classified by the classifier 14 into one of several flow classes 20 and flow instances 22 by the classification rules 18, the rules 18 defining how individual packets should be discriminated from each other.

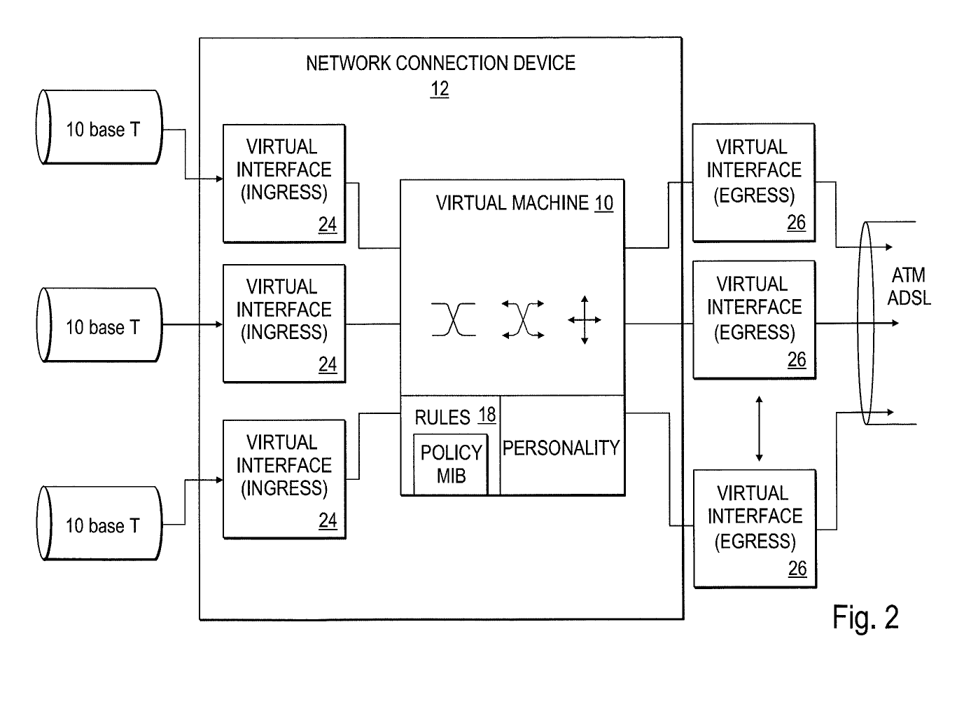

FIG. 2 is a block diagram illustrating an exemplary deployment of a network connection device 12 including the virtual machine 10 that accesses a set of classification rules 18 utilized to make traffic classification decisions. These classification rules 18 may be as simple or as complex as required to make a classification, and may define a “signature” of a particular type of network traffic in order to make a classification. For the purposes of the present location, the term “signature” shall be taken to the information pertaining to network traffic, whether extracted from the network traffic itself or not, that the utilized to characterize or classify network traffic. Within the exemplary deployment shown in FIG. 2, the virtual machine 10 is shown to receive network traffic from a number of 10baseT network connections via a number of ingress virtual interfaces 24, and to output classified network traffic via a number of egress virtual interfaces 26 to an ATM or ADSL network connection. In one embodiment, the virtual interfaces 24 and 26 may constitute a physical port and/or a virtual channel. Network traffic entering one of the ingress virtual interfaces 24 is operationally classified by the virtual machine 10 utilizing the classification rules 18. A packet, frame or cell is then routed, switched or bridged to an appropriate egress virtual interface 26, as defined by the classification rules 18.

For example, at layer-3, packets may be routed between virtual interfaces 24 and 26 based on criteria such as a source or destination Internet Protocol (IP) address, type of service bits, and protocol type. If the egress virtual interface 26 is an ATM virtual interface with multiple VCCs, the virtual machine 10 may operate to compute a quality-of-service-based label with which to forward the relevant packet, as will be described in further detail below. At layer-2, frames may be switched between virtual interfaces 24 and 26 utilizing source and destination MAC addresses, frame type, and encapsulation arrangement. If the egress virtual interface 26 is an ATM virtual interface, then the virtual machine 10 may select a channel, based on QoS requirements specified for the particular layer-2 flow. In one embodiment, the network connection device 12 may be based on a high performance ISE processor which supports dual-switched 10baseT Ethernet ports, a 8 Mbps ADS modem, ATM SAR processing, Ethernet bridging and IP routing.

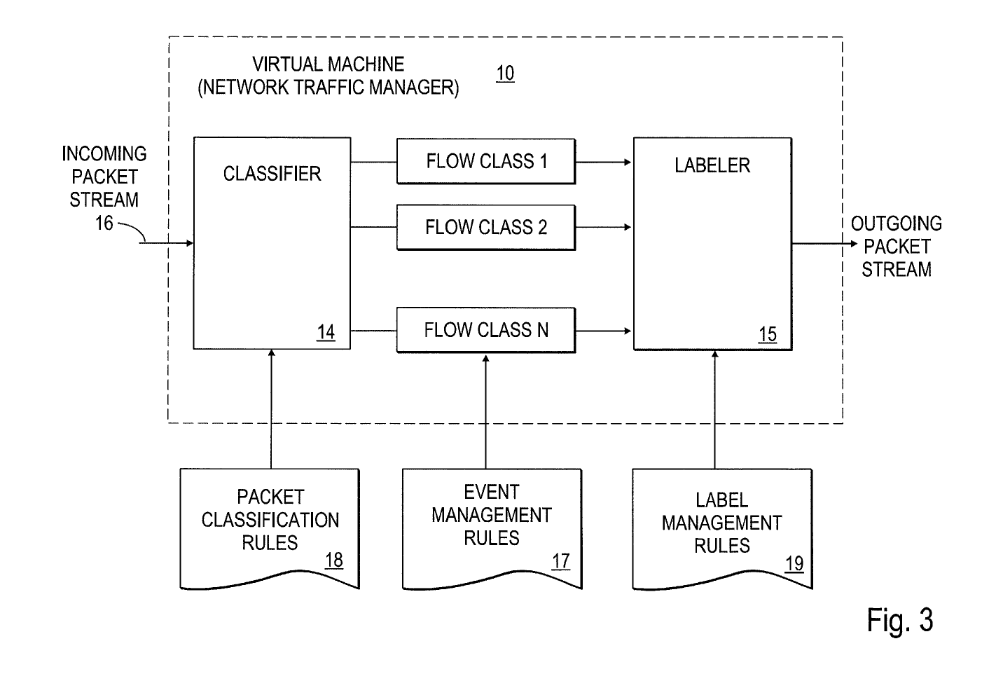

FIG. 3 is a block diagram providing further details of the architecture of an exemplary network traffic manager in the form of a virtual machine 10. The virtual machine 10, in the exemplary embodiment, is shown to include both the classifier 14 and a labeler 15. Dealing first with classifier 14, as described above, the classifier 14 operates to classify a packet, for example, into one of several flow classes and flow instances. To this end, the classifier 14 extracts from each packet a signature, which is then parsed into two distinct fields, namely (1) a flow class discriminator (FCD), which defines the class of the flow to which the packet belongs, and (2) a flow instance discriminator (FID), which identifies to which instance of that flow class the packet belongs. In general, the flow class is utilized to specify transmission control, while a flow instance is utilized to specify admission control.

FIG. 3 illustrates three discrete rules-based processes that may be implemented autonomously. The first rules-based process is the classification process performed by the classifier 14, as discussed above. In one embodiment, the classification rules 18 are configurable via the Simple Network Management Protocol (SNMP). Two further rules-based processes are performed utilizing the illustrated event management rules 17 and label management rules 19. The event management rules 17 and label management rules 19 may, in one embodiment, be configured utilizing compiled virtual machine rules, the compiling of which is further described in this document. Dealing more specifically with event management, a compiled event management rule 17 is associated with significant events in the life cycle of a flow class 20. Examples of such rules and events are provided below in Table 1:

TABLE 1

| Event Management Rule | Event |
|---|---|
| OnCreate | When a new instance of a flow is created, |
| OnDelete | When an instance of a flow is deleted, |
| OnResourceConflict | When a new instance causes a resource |
| | conflict, |
| OnThresholdPositive | When the average data rate rises above the |
| | configured threshold, |
| OnThresholdNegative | When the average data rate falls below a |
| | configured threshold. |

Event management rules 17 may be utilized to tailor fine-grained behavior of the network connection device 12 in support of admission control policies, and to implement appropriate behavior in response to resource reservation protocols (e.g., RSVP). The label management rules 19 are utilized by the labeler 15 to invoke, and respond to, peer-to-peer label exchange protocols (e.g., LDP). This allows dynamic bonding of label spaces to occur between adjacent network devices.

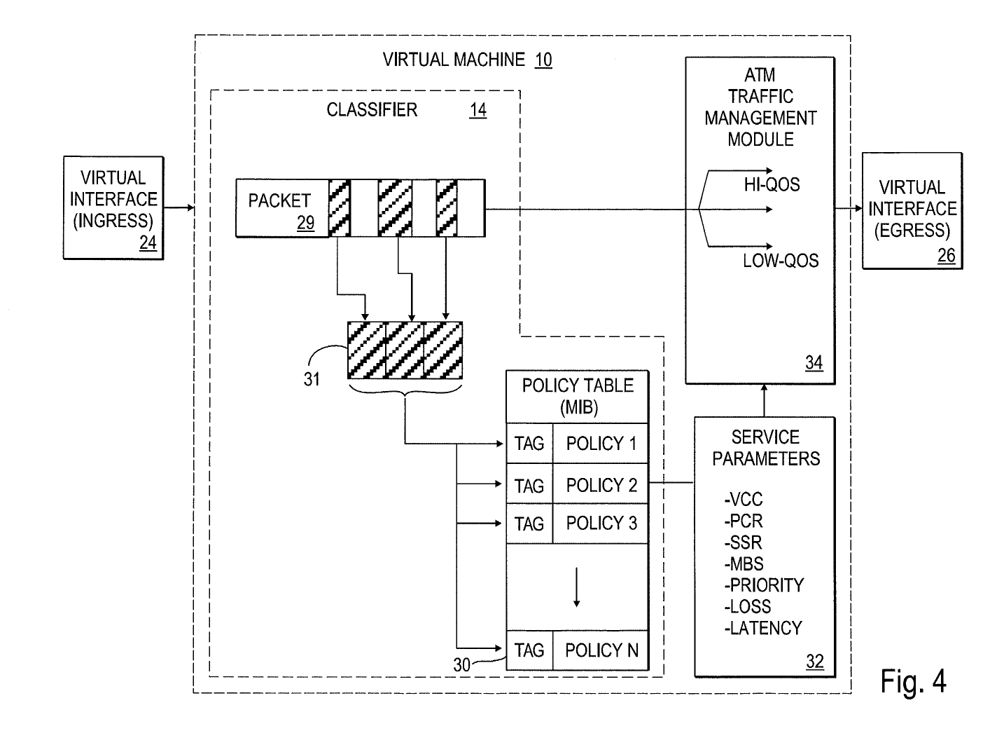

A further discussion regarding an exemplary “signature” is now provided. FIG. 4 is a further block diagram providing a conceptual depiction of the utilization of a packet signature 31, extracted from an incoming packet 29, to identify a policy to be applied with respect to the relevant packet 29. The signature 31 is specified by the classification rules 18, and may comprise any combination of fields and/or data within the packet 29. The signature 31 is utilized as a tag to perform a lookup within a policy table (e.g., a MIB) 30 to locate a policy for handling of the relevant packet 29. The policy may, as illustrated in FIG. 4, specify various service parameters 32. In the exemplary embodiment, the service parameters 32 relate to ATM traffic management, and are provided to an ATM traffic management module 34 that applies the service parameters 32 to various flows outputted via one or more egress virtual interfaces 26. For example, the service parameters 32 may specify that a certain flow is provided with a high QoS, while another flow is provided with low QoS.

The signature 31 of a packet 29 is utilized by the classifier 14 to differentiate the packet 29 from other dissimilar packets. As stated above, sequences of packets (or other network traffic units) bearing in the same signature are termed “flows”. A flow is said to be instantiated when the classifier 14 recognizes a packet 29 bearing the flow's signature, and persists until the amount of time between packets 29 bearing the flow's signature exceeds a particular amount of time (e.g., a flow's Interval Timeout).

The virtual machine 10 does not impose any structure on a signature 31 or a packet 29. For example, in one context, the signature 31 may comprise merely the destination IP address of a packet 29. In another context, the signature 31 may comprise the destination IP address plus a source MAC address. The most appropriate signature 31 for any given context is an engineering concern, and determined by the given context.

The classifier 14 operates to determine the signature 31 of a packet 29 by evaluating a classification rule 18. In one embodiment, a classification rule 18 comprises a Boolean expression involving one or more of the packet fields listed below in Table 2:

TABLE 2

| FIELD | |
|---|---|
| NAME | FIELD DESCRIPTION |
| SMA | The source MAC address of the frame containing the packet |
| DMA | The destination MAC address of the frame containing the packet |
| SIP | The source IP address of the packet |
| DIP | The destination IP address of the packet |
| PRO | The IP protocol field of the packet |
| TOS | The IP Type Of Service field of the packet that is also used |
| | as the DiffServ DS field. |
| SPO | The source TCP or UDP port |
| DPO | The destination TCP or UDP port |
| RXL | The receive label of the packet. This is the label assigned |
| | to the incoming packet (e.g. in the case of MPLS, 802.1q etc). |

In addition, an ingress virtual interface 24 may also be considered an implicit part of a packet signature 31.

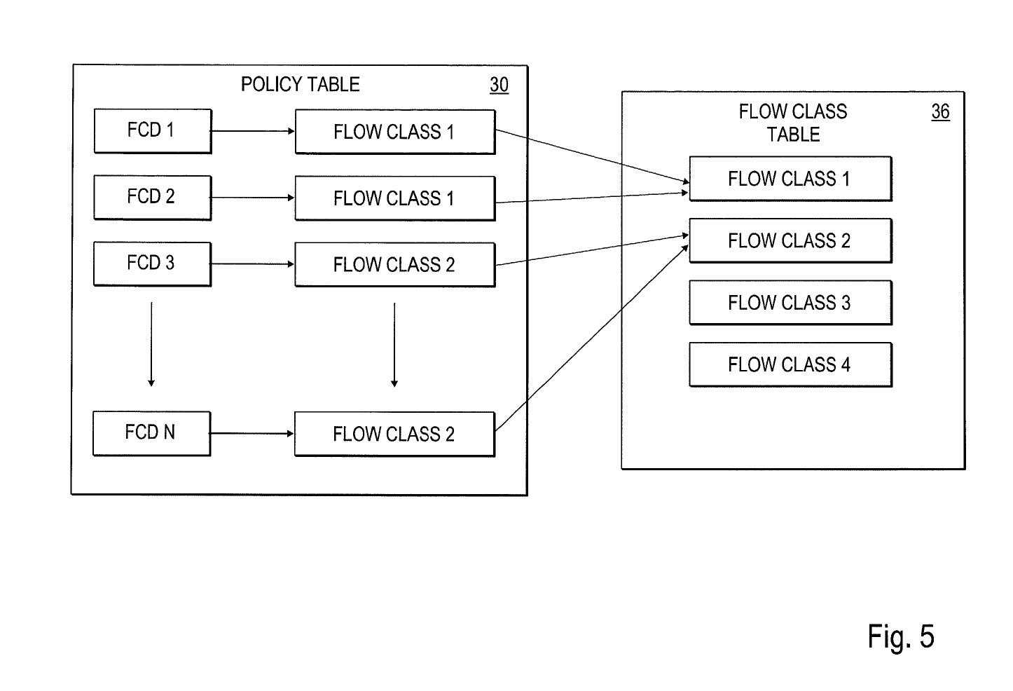

FIG. 5 is a block diagram providing further details regarding the policy table 30, according to an exemplary embodiment of the present invention. The classifier 14, as described above, is configured by making associations between tags (e.g., the flow class discriminators (FCDs)) and their corresponding policies (flow classes) in the policy table 30. In one embodiment, each entry within the policy table 30 is a set of data items, amongst which are specified the fields of the packet signatures 31 to be utilized for classification. Each field (except SMA and DMA) may be given a value and a mask. The SMA and DMA fields each have a value, but no mask associated therewith. Upon receipt of a packet 29, the classifier 14 searches the policy table 30 for an entry that matches the signature 31 of the packet 29. To locate such a match, in one embodiment, the classifier 14 first masks the packet signature 31 with a FCD mask, and then compares it to the FCD value. If the match is successful, the packet 29 is processed as a member of a corresponding flow class. The entries in the policy table 30 may be ordered such that the best match is found first.

FIG. 5 also illustrates a flow class table 36. Once a packet 29 has been classified as a particular flow class, it is processed according to the specification in the flow class table 36. Accordingly, the flow class table 36 should be seen as an exemplary implementation of the policies discussed above with reference to FIG. 4. In one embodiment, the flow class table 36 is a sequence of data items that determine how the relevant flow will behave.

In one embodiment, the flow class table 36 includes a number of fields, namely: (1) an instance selector field, (2) an instance time-out field, (3) a maximum instances field, (4) a transmit code point field, and a (5) reciprocal flow field.

The instance selector field of the class table 36 specifies which fields of a signature 31 of a packet 29 should be utilized to distinguish between instances of a flow class. If there is no instance selector specified within the tables 36, then all packets 29 classified within the relevant flow class are considered as belonging to the same instance.

The instance time-out field specifies the longest inter-packet gap that instances within a particular flow may exhibit. If two packets 29 of the relevant flow are longer apart than this inter-packet gap, they are considered to be in different instances. For example, as shown in FIG. 1, the time between the first and second “A” packets in flow class 1 is shown to exceed the instance time-out.

The maximum instances field specifies the maximum number of simultaneous instances of a particular flow that can exist. In this field the value is set to “N”. A packet 29 that attempts to create a “N+1” instance will be discarded. If a traffic pattern attempts to create too many instances of a flow, the classifier 14 may generate a resource conflict.

The transmit code point field, if specified, includes a value that will become a so-called transmit “behavior code point” for an outgoing packet. The behavior code point is a value that indicates how the virtual machine 10 should forward a flow (i.e., it specifies algorithms that will be used to queue and forward the packet, etc.). Packet forwarding processing is protocol specific, so the behavior code point is a normalization of the semantics associated with packet forwarding. Once a forwarding decision is made in a packet, an egress virtual interface 26 will map this value into it's own pier-to-pier protocol proprietary transmission.

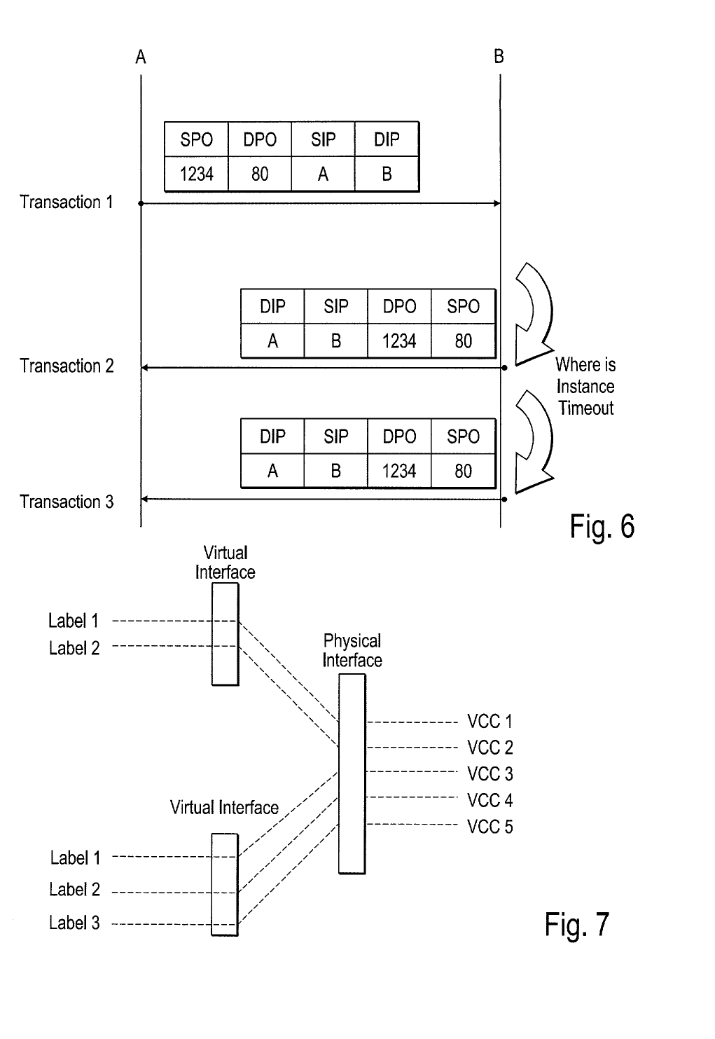

Regarding the reciprocal flow field, a flow can be configured to identify its reciprocal flow (i.e., any traffic in a reverse direction of the flow, which is generated as a result of that flow). This is depicted in FIG. 6, where transactions 2 and 3 occur as a direct consequence of transaction 1. If a virtual interface is not configured to bind it's reciprocal flow, the virtual machine 10 may identify transaction 2 and 3 as two flows (e.g., A.B flow with a count of 1 packet and a B.A flow with a flow of 2 packets). However, if the virtual interface is configured to bind its reciprocal flow, the virtual machine 10 will recognize just a single flow (e.g., an A.B flow with a count of 3 packets).

Both ingress and egress virtual interfaces 24 and 26 are discussed below (e.g., with reference to FIG. 2). In one embodiment, a virtual interface is a logical description of a physical interface, which hides the details of any underlying multiplexing. For example, an ATM physical layer may be mapped as illustrated in FIG. 7.

When the virtual machine 10 switches a packet to an egress virtual interface 26, the flow class to which the relevant packet belongs provides a transmit code point (e.g., the behavior code point discussed above), which specifies the transmission requirements of the relevant flow class. Each virtual interface is created to support a specific network topology, and to specify now to map a packet to and from the external network. Specifically, each virtual interface includes configuration to set the type of underlying physical interface (e.g., Ethernet, VDSL, ADSL, etc.), assign a driver instance (i.e., the realization of the physical layer), assign the label space of the physical layer that the virtual interface can use, set the type of virtual interface (e.g., Ethernet, RFC1483, PPPoverL2TP, etc.), enable disable DHCP, assign a MAC address, assign an IP address and subnet mask (when routing), enable and disable IP multicasting, enable and disable broadcasting to other virtual interfaces of a particular type, enable and disable Network Address Translation, and enable and disable Spanning Tree and set state (e.g., blocking, listening, forwarding, etc.) priority and cost.

In addition, a virtual interface, in one embodiment, contains the following information: received unicast bytes and packets, received multicast bytes and packets, received broadcast bytes and packets, receiver discarded bytes and packets, transmitted bytes and packets, and transmitter discarded bytes and packets.

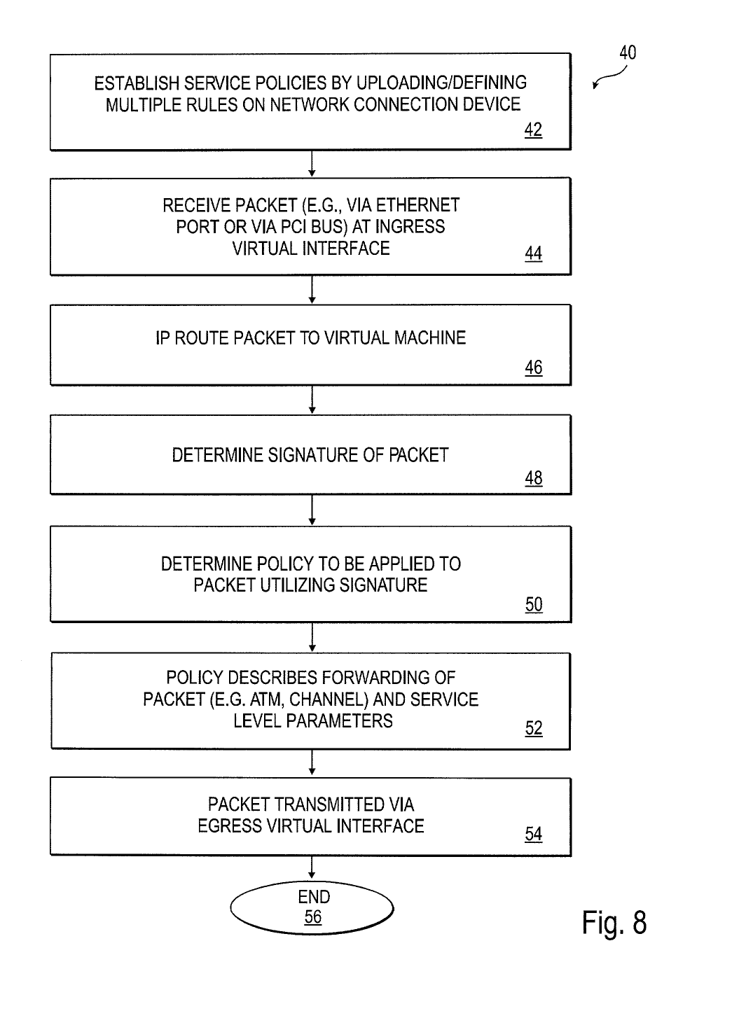

FIG. 8 is a flow chart illustrating a method 40, according to an exemplary embodiment of the present invention, of implementing policy-based network traffic management. The method 40 commences at block 42, with the establishment of service policies (e.g., specified within the policy and/or flow class tables 30 and 36). These policies may be defined by uploading and/or defining multiple rules (e.g., classification rules, 18, event management rules 17, and label management rules 19) on a network connection device 12.

At block 44, a packet 29 is received at an ingress virtual interface 24 (e.g., via a Ethernet port or via a PCI bus). The packet 29 is then IP routed to the virtual machine 10 at block 46. At block 48, the signature, as described above, for the packet 29 is determined. At block 50, a policy to be applied in processing of the packet 29 is identified by utilizing the signature to perform a lookup on the policy and/or flow class tables 30 and 36.

The forwarding (and processing) processes (e.g., the identification of an ATM channel), and service level parameters as specified by the identified policy are then determined at block 52. At block 54, the relevant packet 29 is then transmitted, according to the policy, via an egress virtual interface 26. The method 40 then terminates at block 56.

The Virtual Machine Compiler

Many network devices incorporate a number of software and hardware subcomponents (e.g., IP, PPP, ATM, etc.), each of which has individual characteristics and parameters. The correct operation of the network devices depends on the correct configuration of component parameters of these subcomponents, or of the network architecture.

Component parameters are often dependent on each other, and may be mutually exclusive. Correct configuration of a network device requires careful consideration of these dependencies. Network management devices typically allow for the setting of individual component parameters, but do not enforce a net result of a series of discrete configuration operations. This may be due to the large amount of resources required in both the managing and managed devices to perform such a task. The above problem of configuring component parameters, which may be dependent upon each other, is becoming more prevalent as network devices are becoming smaller, more numerous, more functional, low cost, and more mission critical. Specifically, network devices are being increasingly deployed (some in mission critical applications), and network administration is becoming an increasing expense for organizations. The volume deployment of broadband services is contributing towards the exasperation of the above-identified problem.

According to one embodiment of the present invention, a proposed solution to address the above identified network management problems includes compiling the outcome of a number of discrete configuration steps into an indivisible rule, which instructs a network device how to behave. This result may provide the advantage of allowing configuration tasks to be performed more reliably (and with a smaller code footprint), and also provides a mechanism for increasing the resolution of configuration without an adverse effect on the device's MTEF. Increased management resolution allows a network designer, for example, to safely exert control over very detailed aspects of the behavior of a network device, such as flow classification and data path features.

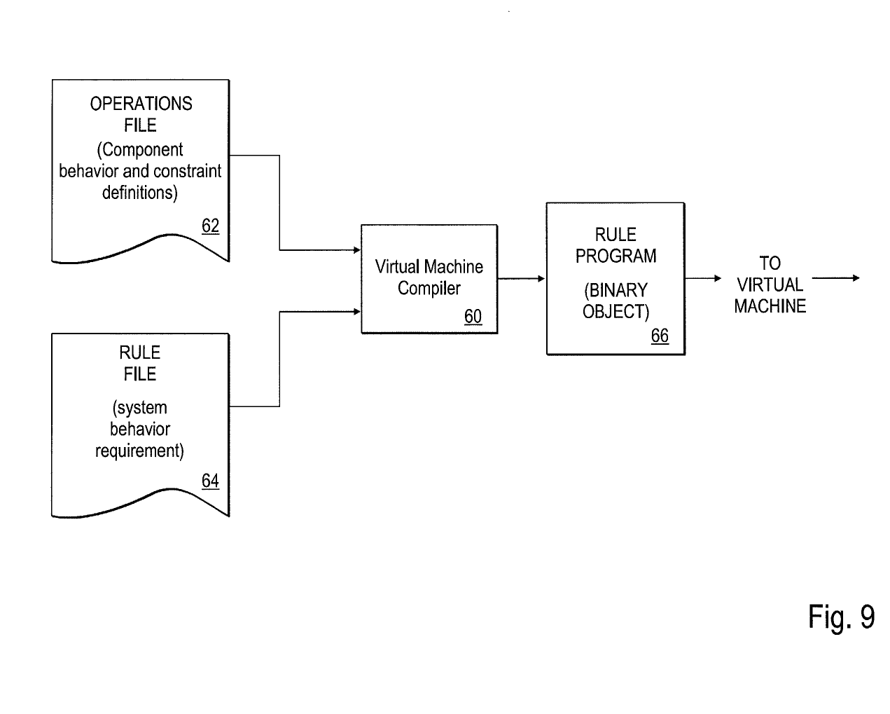

FIG. 9 is a block diagram providing a high level diagrammatic representation of the operation of a virtual machine compiler 60, according to an exemplary embodiment of the present invention. The virtual machine compiler 60 is shown to receive as inputs: (1) an operations file 62 that describes operations supported by components of a particular network device (i.e., component behavior) and constraint definitions, and (2) a rule rile 64 that specifies behavioral requirements of a specific network device. In one embodiment, these behavioral requirements may be specified as a textual representation in the form of a decision tree.

The virtual machine compiler 60 utilizes the operations file 62 and the rule file 64 to compile a rule program 66, which in one embodiment comprises a binary object including a sequence of instructions suitable for the virtual machine 10, discussed above. The rule program 66 comprises a set of operations, selected from operations supported by components of the network connection device 12, for performance by the respective components of the network connection device in accordance with the behavioral requirements defined by the rule file 64. In one embodiment, the rule program 66 may embody a number of sequences, these sequences constituting the classification rules 18, the event management rules 17 and the label management rules 19 discussed above with reference to FIG. 3.

The virtual machine compiler 60 is accordingly used to define the behavior of a virtual machine 10 in a secure and performance-oriented manner by loading the rule program 66 into the key locations of the virtual machine 10.

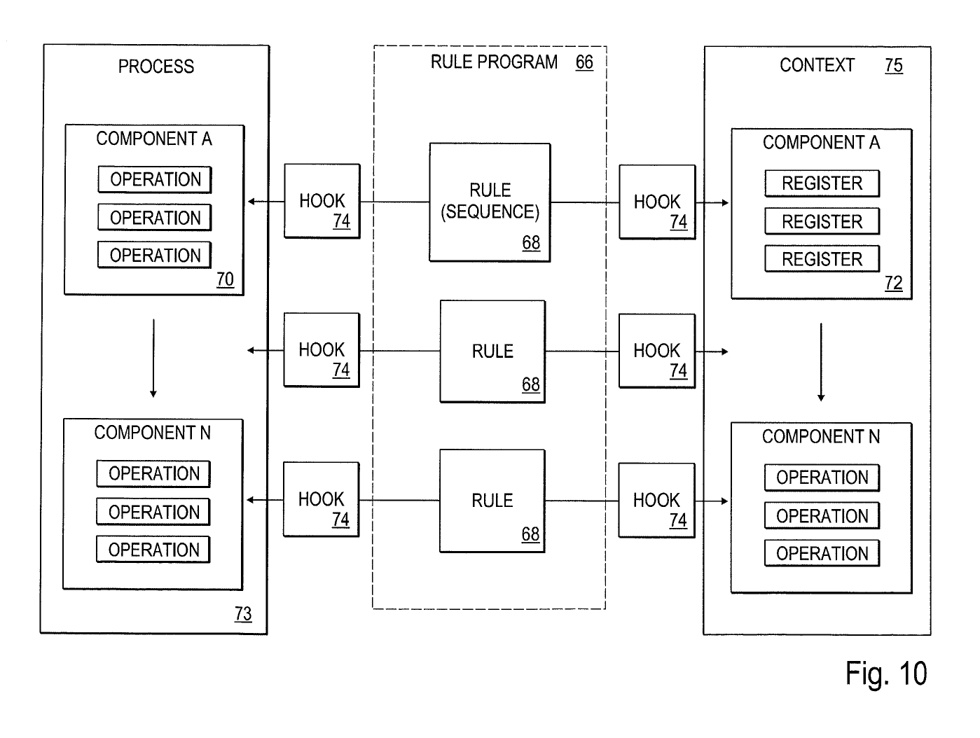

The virtual machine compiler 60, in one embodiment, presents a model to a rule designer that consists of a number of abstract data processes and contexts, as illustrated in FIG. 10. Specifically, FIG. 10 illustrates the rule program 66 as conceptually comprising a number of rules 68 (i.e., instruction sequences) that are utilized to bind process behavior definitions, conveniently labeled operations 70, to contextual zed sets of data, conveniently labeled registers 72. It will be appreciated that because a specific network connection device 12 may be constituted by a number of smaller components, the overall process and context for a network connection device 12 may similarly viewed as constituting a number of corresponding components. As illustrated in FIG. 10, each component (e.g., the TCP protocol or an ATM device driver) that wishes to contribute to a process (e.g., an abstract entity such as a data plane or the management plane) can operate, via a rule 68 class on a new or existing register 72.

A particular component may together itself as multiple processes. For example, a component TCP may provide operations in both a data plane process, and a management plane process.

A rule 68 is declared to be for a specific process 73, hook 74 and context 75, and the virtual machine compiler 60 operates to insure that all components and operations used in a specific rule 68 are compatible with that declaration. A hook 74 may be regarded a location within a process to which a rule 68 may be addressed. Once a rule program 66 is written and tested, it may completely describe the behavior of a network connection device 12.

Dealing more specifically with the rule program 66, a rule program 66 may, in one embodiment, comprise a formal, compiled set of operations that is checked for consistency before being submitted to a network connection device 12. Discrete management operations (e.g., SNMP sets for such checks) are mutually exclusive, and may result in an inoperable network connection device 12 in the absence of such a consistency check.

To this end, a rule 68 is authenticated by its author, and checked by the network connection device 12 before execution. This provides security at a functional level, whereas security at a protocol level (e.g., SNMP) only authenticates access to the system, not the result of any operations performed.

The rule program 66 is furthermore compiled and loaded into a network connection device 12 independent of any run-time management protocol, and in this way so-called “unmanaged” systems can be configured which retain the ability to be characterized.

Furthermore, as a rule program 66 is compiled, it executes relatively efficiently and quickly from a processing standpoint. This allows the benefit of a consistent approach and tool-set to be used to define data-path behavior (e.g., packet filtering and policy configuration) and conventional configuration management (e.g., assignment of IP addresses, etc.). Furthermore, a rule program 66, in one exemplary embodiment, is a compiled binary object that can be “assigned” by an authenticating authority, and distributed in the knowledge that it will only execute on applicable systems.

A further explanation of an exemplary embodiment of an operations file 62 will now be provided. As described above, the operations from which the rule program 66 is built are contained in the operations file 62.

An exemplary implementation of the virtual machine 10 may be broken down into a number of discrete and re-useable software parts, termed components, each of which has as section within the operations file 62 that described the operations supported by the respective component. A product model may be viewed as a specific instance of a virtual machine 10, which has a defined set of components. The virtual machine 10 described by a product model is only capable of executing the operations of its constituent components. Each component is assigned a global identity, and has its own operations namespace. At run time, the implementation of each component registers its operation with the virtual machine compiler 60. When a new rule is introduced into a network connection device 12 (e.g., via a network management or from memory), the virtual machine compiler 60 checks for consistency between a new rule and its registered implementation. An assigned identifier between 1 and 1216-1 may identify components.

Referring again to FIG. 10, rules 68 in the rule program 66 are associated with abstract entities created by the virtual machine 10. These abstract entities are defined in terms of their behavior and their data. A particular process 73 uniquely identifies a particular behavior, and a context 75 uniquely identifies a particular data environment. A process 73 and a context 75 required for correct operation of a rule program 66 are coded into an instruction sequence of the relevant rule program 66. The virtual machine 10 checks that the registered implementations supports the same process 73 and context 75 as required by a specific rule 68. The grammar of an exemplary operations file 62 is provided below:

<vopFile>

| | | |
|---|---|---|
| <vopFile> | ::= | <contextDeclarations> |
| | | <processDeclarations> |
| | | <componentDeclarations |
| <contextDeclarations> | ::= | (“CONTEXT”<context-ident>“=”<context-number>)+ |
| <processDeclarations> | | (“PROCESS”<process-ident>“=”<process-number><processSchema>)+ |
| <processSchema> | ::= | “BEGIN”(<hook-ident>“=”<hook-number>)+“END” |
| <componentDeclarations> | ::= | “COMPONENT”<component-ident>“=”<component-number> |
| | | (<useDeclaration>(<operationDeclaration>)+)+ |
| <useDeclaration> | ::= | “USES”<context-ident>(“,”<context-ident>)* |
| <operationDeclaration> | ::= | <operation-type><mnemonic-ident><function-ident><signature>“=” |
| | | <op-number> |

where:

| | |
|---|---|
| <number> | is any valid number between 0 and 65535 which forms the high-order 16-bits |
| | of the 32-bit GOP. |
| <ident> | is any valid identifier |
| <context-ident> | is the <ident> which is the name of a context |
| <context-number> | is the <number> which is the global context identity of the context named |
| | <context-ident>. |
| <process-ident> | is the <ident> which is the name of a process |
| <process-number> | is the <number> which is the global process identity of the process <process- |
| | ident> |
| <hook-ident> | is the <ident> which is the name of a hook within a process. |
| <hook-number> | is the <number> which is the process scoped identity of the hook <hook- |
| | ident> |
| <component-ident> | is the <ident> which is the name of a component |
| <component-number> | is the <number> which is the global identity of the component <component- |
| | ident> |
| <mnemonic-ident> | is the <ident> which is the operation's mnemonic. |
| <function-ident> | is the <dent> which is the name of the C function which implements the |
| | operation. |
| <signature> | is the signature of the operation as described below. |
| <op-number> | is the <number> which is the operation's identity which forms the low-order |
| | 16-bits of the 32-bit GOP. |

Furthermore, each operation 70 of a component may, in one exemplary embodiment, be declared as one of three types:

| | | |
|---|---|---|
| <operation-type> | ::= | “ACTION” |
| | \| | “PREDICATE” |
| | \| | “MONITOR” |

where:

| | |
|---|---|
| ACTION | is an operation which attempts to changes the state of the system and if |
| | successful will PASS, otherwise will FAIL. An action is assured not to |
| | change the state of the system when it fails. |
| PREDICATE | is an operation which tests the state of the system. If the test is true the |
| | operation will PASS. If the test is false the operation will FAIL. |
| MONITOR | is an operation which may or may not change the state of the system and can |
| | neither PASS nor FAIL. |

Operationally, the virtual machine compiler 60 insures that a rule program 66 does not execute a predicate operation after an action operation has been executed, because the change of systems implied by the action precludes any backtracking. A monitor operation (not shown) may change the state of a network connection device 12, as long as it does so in a manner that is transparent to execution of the rule program 66. For example, suppose a particular component provides an operation that looks for IP addresses for a particular sub-net, and then sends such IP addresses to a cache. If the presence of the IP address in the cache is still valid, even if the rule contains an operation that subsequently fail, then the operation should be declared as a monitor, otherwise it is declared as an action.

Turning now to the rule file 64, as stated above the rule file 64 is text that is converted into a binary-form rule program 66. Within the rule file 64, in one exemplary embodiment, a number of rules may be defined, each rule comprising a decision tree having the general form:

IF <predicate>THEN <action>ELSE <action>

It will be appreciated that complex decision trees may be built utilizing further IF . . . THEN . . . ELSE statements within the rule file 64. Both predicates and actions are made up of sequences of operations, each of which can either PASS or FAIL when executed. The THEN-part statement of a particular rule is executed if all the operations of the IF-part pass. The ELSE-part statement of a particular rule is executed if any one of the operations of the IF-part FAIL.

The grammar for an exemplary rule file 64 is provided below:

<rule>

| | | |
|---|---|---|
| <rule> | ::= | “RULE”<ident><ruleHdr>“BEGIN”<ruleBody>“END” |

where:

| | |
|---|---|
| <ident> | is the name of the rule 68. The virtual machine compiler 60 will generate a |
| | warning if the name of the rule 68 does not conform to the name of the input |
| | file (less the extension). |

<ruleHdr>
The rule header contains information which pertains to all the whole rule 68.
The grammar of the rule header is:

| | | |
|---|---|---|
| <ruleHdr> | ::= | <processDecl><contextDecl>[<keyDecl>](<constant>\|<macro>)* |

<processDecl>
The process of a rule 68 describes the behavioral environment in which the rule 68 is expected to run. The
process declaration includes the hook point to which the rule 68 is targeted.

| | | |
|---|---|---|
| <processDecl> | ::= | <process-ident>“(“<hook-ident>“)” |

The cont <contextDecl>
The context of a rule 68 describes the data environment in which the rule 68 is expected to run. The environment
includes the data areas the operations of the rule operate on, and the revision of the operations to be used.

| | | |
|---|---|---|
| <contextDecl> | ::= | “USES”<context-ident> |

where:

| | |
|---|---|
| <context-ident> | is an <ident> which is the global name of a context |

<keyDecl>
The key of a rule 68 is hexadecimal string which used to authenticating the rule's origin. When the virtual
machine 10 loads a rule, it ensures that the key of the rule 68 is compatible with a “shared secret” that has been
assigned to the relevant network device.

| | | |
|---|---|---|
| <keyDecl> | ::= | “KEY”““<key-hstring>”” |

| | |
|---|---|
| where: | |
| <key-hstring> | is an <hstring> which forms the authentication key for this rule |
| <constant> | |

Constant data items are compiled into the heap-objects or inline-objects and can be refereed to by use of an
assigned identifiers.

| | | |
|---|---|---|
| <constant> | ::= | <heapObject> |
| | \| | <inlineObject> |

<heapObject>
A heap object is to be stored in an area of the rule 68 called the parameter heap. These items are treated as
contiguous, modulo 4 sequence of bytes. The first 2 bytes of the heap object is the type field, the second 2 bytes
of the heap object is the length field in bytes, and the remaining bytes are the objects value followed possibly by
padding.
Heap objects are declared in the rule using the following grammar:

| | | |
|---|---|---|
| <heapObject> | ::= | “STRING”<ident>“=”“““<cstring>””” |
| | \| | “DATA”<ident>“=”““'<hstring>'““ |

where:

| | |
|---|---|
| <cstring> | is any sequence of printable characters |
| <hstring> | is any sequence of the characters “0”..“9”, “A”..“F” and “a”.. “f” |

e.g.

STRING CompanyName=“Xstreamis plc.”
DATA macAddress '1122AB33DA76'

In order to use a heap object an operation must be declared with an “o” in the appropriate place in
it's signature.
<inlineObject>
An in-line constant object is declared using the following grammar:

| | | |
|---|---|---|
| <inlineObject> | ::= | “INTEGER”<ident>“=”<number> |

Subsequent to the declaration of a constant, any use of <ident> in a rule 68 will result in it being replaced by the
value <number>.
Note that constants do not reside on the heap, but are placed in the instruction stream in the same manner as an
integer literal.
<macro>
A macro is a specification of a sequence of operations which can be referred to by a given name. Wherever the
given name appears in a rule 68, it is replaced with the specified sequence of instructions.

| | | |
|---|---|---|
| <macro> | ::= | “DEFINE“<macro-ident>“{“<macroBody>”}” |

where:

| | |
|---|---|
| <macro-ident> | is an <ident> which is used to identify the macro |
| <macroBody> | is a sequence of operations assigned to the macro identifier. |

The virtual machine compiler 60 will interpret any appearance of the <macro-ident> as if it were an appearance
of the <macroBody>.
<ruleBody>
The body of a rule 68 has the following grammar:

| | | |
|---|---|---|
| <ruleBody> | ::= | <clause>* |
| <clause> | ::= | <expression>* |
| | \| | “IF”<clause>“THEN”<clause>“ELSE”<clause> |
| <expression> | ::= | <complexExpression> |
| | \| | <literal> |
| | \| | <macro-ident> |
| | \| | <operation> |
| | \| | “(“<expression>“)“ |

where:

| | |
|---|---|
| <complexExpression> | is a complex in-fix, post-fix or pre-fix expression (this grammar can be seen |
| | in more detail in http://vm.html). |
| <literal> | is a hexadecimal or decimal constant. |

<operation>
This is the invocation of an operation defined in the operations file 62. The name of an operation is the
mnemonic identifier assign to it in the operations file 62, qualified by the types of the arguments in the argument
list, and the rule's context declarations.
A component may have multiple operations with the same mnemonic identifier, but with different argument-type
or in different contexts or packages.

| | | |
|---|---|---|
| <operation> | ::= | [“NOT”]<mnemonic-ident>[“(“argList”)”] |
| <argList> | ::= | [<expression>[“,”<expression>]] |

where:

| | |
|---|---|
| <mnemonic-ident> | is an <ident> which is the mnemonic assigned to an operation in the VOP |
| | file. |
| <argList> | is a sequence of zero or more expressions which form the arguments to the |
| | operation corresponding to <mnemonic-ident>. |

If the NOT key word precedes the operation then the negation-bit is set in the LOP code of the operation causing
the virtual machine 10 to invert the sense of the operation.
<literal>
A literal object is a 32-bit value stored in the instruction stream. When an operation is called, the virtual
machine's instruction pointer points to the first literal value (if any) and it is the responsibility of the function
implementing the operation to advance the instruction pointer beyond all the expected literal objects (i.e. leaving
it pointing to the next operation code).

| | | |
|---|---|---|
| <literal> | ::= | <number>\|<heapObject-ident>\|<const-ident> |

where:

| | |
|---|---|
| <number> | is any decimal or hexadecimal value between 0 and 2¹⁶ − 1. |
| <heapObject-ident> | is an <ident> which is assigned to a <heapObject> |
| <const-ident> | is an <ident> which is assigned to a <constant> |

Turning now to the rule program 66, a rule program 66 may, in one exemplary embodiment, be loaded into a virtual machine 10 as a sequence of 32-bit values stored in a network endian (e.g., big-endian) type order. In one embodiment, rules within the rule program 66 may be encoded as described below, with all links and indices are of networked-entities:

| | |
|---|---|
| r=0:zzzz | Magic number (0 × 52554c61) |
| 1:pppp | Process ID |
| 2:hhhh | Hook ID |
| 3:cccc | Context ID |
| 4:-xx- | Length everything except the first 3 fields |
| 5:f(1) | Index to last valid opcode |
| 6:f(n) | Index to first GOP |
| KKKK | (i.e. value equal to 5 means no TLVs) |
| KKKK | |
| KKKK | |
| op(1):GOP1 | GOP of first operation |

| | |
|---|---|
| op(1)+1:LOP1 | LOP of first operation |
| op(1)+2:LIT1 | first argument to f1 |
| op(1)+3:LIT2 | second argument to f1 |
| op(2)=op(1)+arity(1):GOP2 | |
| op(2)+1:LOP2 | LOP of first operation |
| op(2)+2:LIT2 | first argument to f2 |
| op(2)+3:LIT2 | second argument to f2 |
| ˜˜˜˜ | |
| op(n)=op(n−1)+arity(n−1):GOP2 | |
| op(n)+1:LOP2 | LOP of first operation |
| op(n)+2:LIT2 | first argument to f2 |
| op(n)+3:LIT2 | second argument to f2 |
| h(1)=op(n)+arity(n):-h1- | The -h1- field describes the length of the |

parameter heap.

| | |
|---|---|
| h(1)+0:tlv1 | The tlv1 field describes the type and length |
| vvvv | of the first parameter heap value. |
| vvvv | |

| | |
|---|---|
| h(1)+tlv1.len:tlv2 | The tlv2 field describes the type and length |

| | |
|---|---|
| vvvv | of the second parameter heap value. |
| vvvv | |
| h(1)+tlv1.len+tlv2.len:???? | |
| =r(1)+xx÷1 | |

1. Magic Number

Word 0 of the rule is a 32-bit number which identifies the word sequence as a valid rule 68.

Encoded within the number is the revision of the structure of the rule 68.

2. Rule Context

Words 1 and 2 of the rule indicate the context of the rule 68.

Word 1 is the virtual machine context, and

Word 2 is the component context.

The virtual machine compiler ensures that all the operations used in a rule 68 operate only on one of these two contexts.

All context and operation associations are made in the operations file 62.

Rule length

Word 3 of the rule 68 is its length of the rule 68. The value encoded is the length of the rule 68 from the current position, i.e.

<length of rule>−3.

3. Last GOP index

Word 3 of the rule 68 is the Last GOP Index. This is the offset from start of the rule to the last GOP of the operation sequence. The virtual machine uses this value to locate the start of the heap.

4. First GOP index

Word 4 of the rule is the First GOP Index. This is the offset from the start of the rule 68 to the first GOP of the operation sequence. The virtual machine 10 uses this value to locate presence of the authentication key and the start of the operation sequence.

4.1 Authentication Key

Word 5 contains the optional authentication key which occupies zero or more words between the First GOP index and the first GOP of the operation sequence. If there is no authentication key, then Word 5 contains the first GOP of the operation sequence.

5. Operation Sequence

Following the authentication key is a sequence of operations. Each operation consists of a GOP, a LOP and zero or more literals.

5.1 Global Operation Code

The GOP is a 32-bit value which universally identifies an operation. The GOP is formed by the concatenation of the 16-bit component identifier, and the 16-bit operation identifier.

5.2 Local operation Code

The LOP identifies the numbers of arguments that an operation requires, and hence the overall length of the encoded operation. The virtual machine overwrites values in the LOP with certain run-time information during the loading of the rule 68 into the virtual machine. LOPs are structure as follows:

AAAA NFFF FFFF FFFF UUOO OOOO OOOO OOOO

where:

| | |
|---|---|
| A | The arity of the operation (i.e. the number of literal arguments it |
| | consumes from the instruction stream). |
| N | Negative Sense-the virtual machine must invert sense of the operation |
| | (i.e. an operation which PASSES will cause it's containing clause |
| | to FAIL). |
| F | The fail offset (i.e. the number of operations to skip before continuing |
| | in the event that this operation should FAIL) |
| U | Unused |
| O | Operator function index. The VM overwrites this when it binds the |
| | rule into the system. |

5.3 Arguments

The operation arguments are values which are passed to the operation. The number of arguments in the instruction stream are encoded in the LOP in the ‘arity’ field. The value of an argument is either a 32-bit literal value, or a 32-bit offset from the start of the rule to a heap object.

6. Heap Objects

The heap contains constant data that is passed to operations as arguments. The first word of each heap object is header containing a 16-bit object identifier and a 16-bit object length. The object identifier has a value of 1 if the object is a character string, and a value of 2 if the object is a hex string. The object length is in bytes.

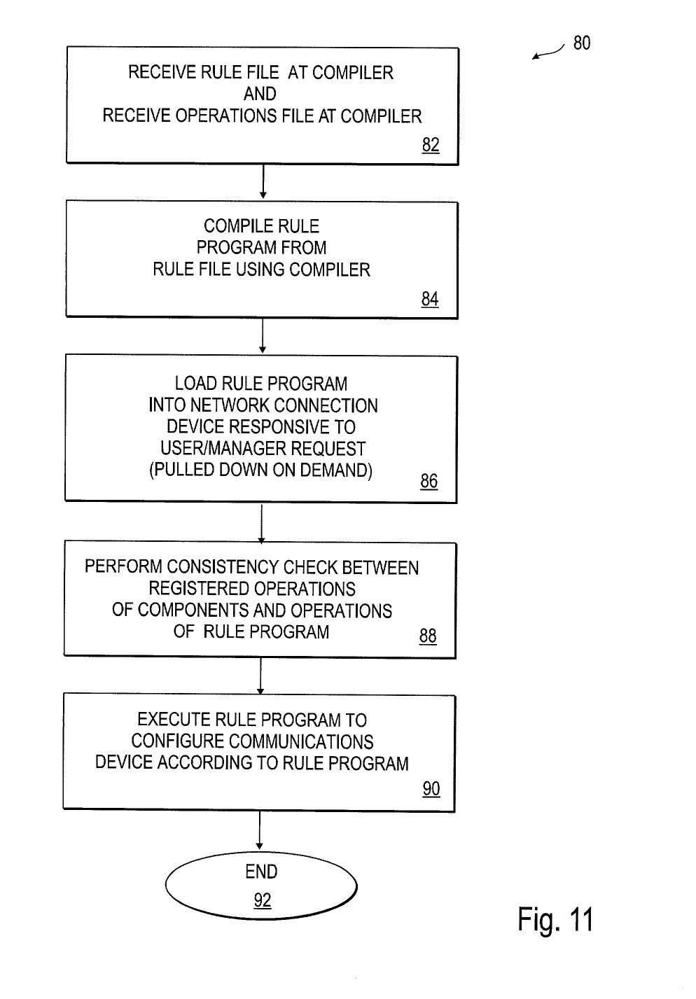

FIG. 11 is a flow chart illustrating a method 80, according to an exemplary embodiment of the present invention, to pre-compile configuration information for a network connection device 12. At block 82, the operations file 62 and the rule file 64 are received at the virtual machine compiler 60.

At block 84, the virtual machine compiler 60 compiles the rule program 66 utilizing the operations files 62 and the rule file 64, for example in the manner described above.

At block 86, the rule program 66 is loaded into the network connection device 12, responsive to a user (or manager) request. For example, the rule program 66 may be loaded into the network connection device 12 from a remote location on demand from a user or manager.

At block 88, the virtual machine 10, operating on the network connection device 12, performs a consistency check between registered operations of components, and operations of the rule program 66.

At block 90, the rule program 66 is executed by the virtual machine 10 to configure the network connection device 12 (and more specifically the components of the network connection device 12) according to the rule program 66. The method 80 then ends at block 92.

Virtual Network Interface Card and Out-of-Band (OOB) Communications

According to a further aspect of the present invention, there is provided a client application that executes on a network client device (e.g., a workstation 102) so as to allow a network connection device 12 (e.g., a switch, bridge or router) to interact with a network client device as though it were a host-coupled device. The client application provides a number of functions, which will be described below. In the exemplary embodiment described below, the client application has been conveniently labeled as a virtual network interface (VNIC) client application 100. It will nonetheless be appreciated that this is merely a convenient label for the exemplary embodiment.

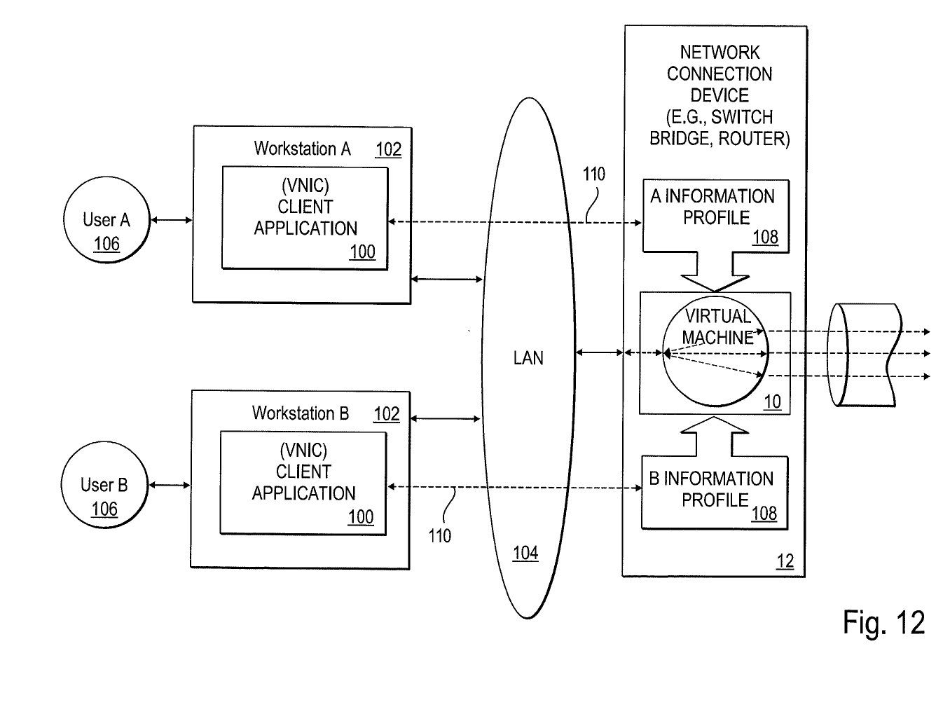

FIG. 12 is a diagrammatic representation of an exemplary deployment scenario in which a VNIC client application 100 is hosted on each of workstations 102 coupled to a network connection device 12 via a local area network (LAN) 104. A user 106 is also associated with each of the workstations 102.

The VNIC client applications 100 each execute on a respective workstation 102 to provide services discussed below. The VNIC client applications 100 also optionally each install a small icon on the task bar of a user's desktop to communicate status information (e.g., QoS parameters, network traffic parameters, policy decision information regarding policy decisions made by the virtual machine 10, etc.) to the relevant user 106.

The network connection device 12, in one exemplary embodiment, hosts a virtual machine 10, as described above, to implement policy-based network traffic management. It should however be noted that the VNIC client applications 100 provide optional functionality to the virtual machine 10, and are not required to enable the virtual machine 10 to perform the above-described policy-based network traffic management. In one embodiment, the VNIC client application 100 works in conjunction with the virtual machine 10 to provide enhanced policy-based network traffic management capabilities. For example, the VNIC client application 100 operates to bring advantages typically associated with host-coupled devices (e.g., an Ethernet card or a WAN adaptor) to the centrally positioned network connection device 12. Such advantages include the ability of an administrator to alter the behavior of the network connection device 12 on a user or work group basis, the ability to have one on one interaction (e.g., via pop-up dialogs and selection menus) between a user and a network connection device 12, the ability to interact with a user application to gain insight into traffic requirements without the need for specific inband QoS signaling, the ability for the network connection device 12 to participate in, and be subject to, a network authentication mechanism, and the ability for client-site agents (e.g., Java applets) to be deployed which can interact with a policy network traffic management strategy implemented by a network connection device 12.

In order to provide these advantages, FIG. 12 illustrates each VNIC client application 100 contributing to an information profile 108, maintained by a profiler and utilized by a network traffic management application, in the exemplary form of the virtual machine 10, to perform policy-based network traffic management. In one embodiment, the VNIC client application 100 utilizes out-of-band (OOB) signaling between a respective workstation 102 and the virtual machine 10 to contribute to the information profile 108 accessed by the virtual machine 10. The information contributed to an information profile 108 may include, for example, data concerning network access rights of a user, or associated with a particular workstation 102. The network access rights may, for example, be specified as a particular bandwidth attention to a particular user or workstation, as a community membership, etc. The information contributed to information profile 108 may also include information concerning network access requirements of a user or workstation 102(e.g., bandwidth requirements), data concerning network traffic conditions at a workstation 102, or a data retrieved from a registry associated with a workstation (e.g., information indicating membership of a workgroup).

An information profile 108 allows the virtual machine 10 to take into account information beyond that contained in a packet when classifying traffic. Specifically, information contained within an information profile 108 can be utilized by the virtual machine 10 to supplement a policy-based network traffic network strategy. The VNIC client application 100 may furthermore continually update the information profile 108. For example, when a user 106 logs on to a workstation 102, and is authenticated by a network domain or a group, information regarding the user may be continually forwarded by the VNIC client application 100 to the virtual machine 10. The virtual machine 10 may respond with information indicating resources that are required by a current traffic load of a user 106, and whether or not such resources are currently available. Such an exchange may occur within the context of a “keep-alive transaction” that delimits a user session. The “keep-alive transaction” also provides a discrete event to the network connection device 12, which in turn allows it to more accurately manage the resources at its disposal.

As described above, when a packet 29 is received at the virtual machine 10, it may be classified by examining various parts of the packets structure, and assigning it to a flow according to a set of rules that reflect a network administration policy.

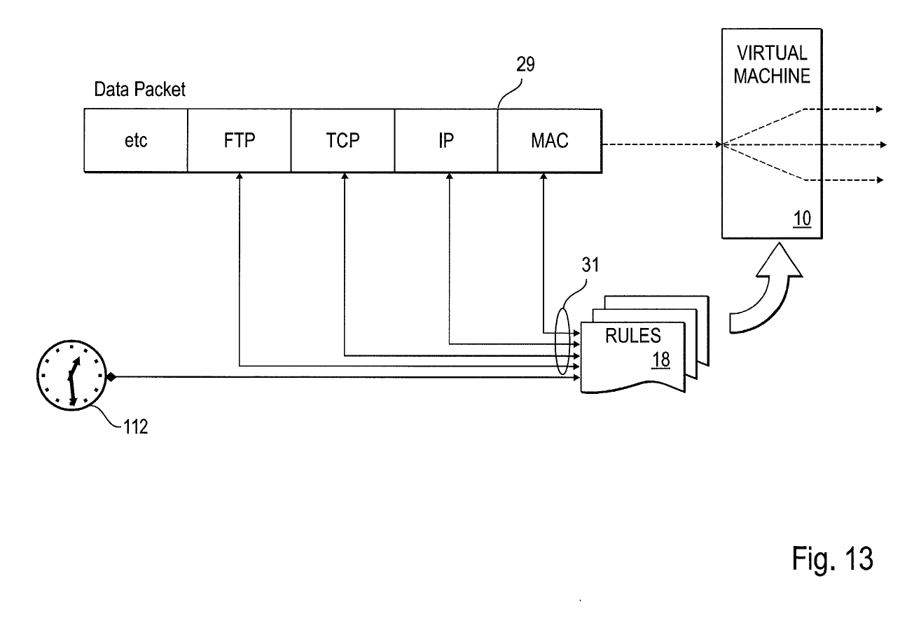

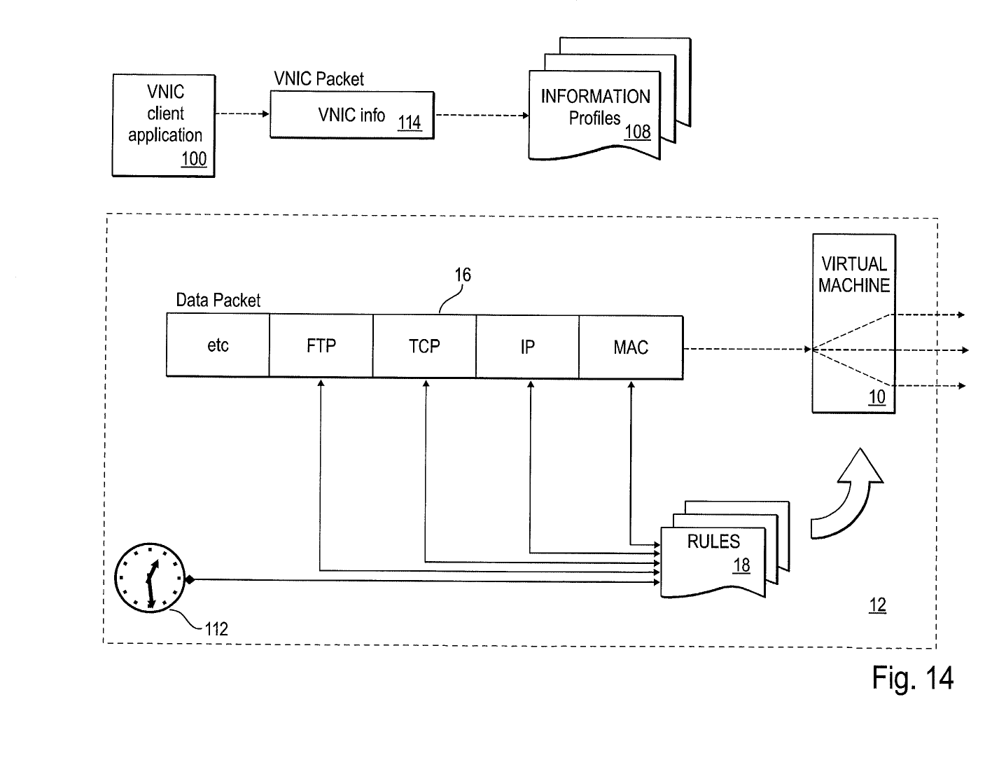

According to one aspect of the present application, in addition to utilizing information which may be present within the packet 29 itself, the classification rules 18 may also consider physical information (e.g., a receiving port) and contextual information (e.g., time of day, the occurrence of a given event, the previous receipt of a particular packet, the amount of time between packets as an indication of traffic density). To this end, FIG. 13 diagrammatically represents classification rules 18 utilizing both a signature 31 received from a packet 29 and time of day information 112. According to a further aspect of the present invention, the classification rules 18 utilizes information concerning the physical characteristics of the network connection device 12 (e.g., the port of the device 12 if Columbus thinking Congress thinking I was going to get a good context of a check on which particular network traffic is received) to implement a network traffic policy.

It will be appreciated that by utilizing the detailed information extracted from the packet 29, and applying the classification rules 18, the virtual machine 10 is able to discriminate flow classes 20 to a high resolution. However, the amount of information that may be inferred by merely observing data passing through a network connection device 12 is limited. The VNIC client application 100 operates to make additional information available to the classification process implemented by the virtual machine 10 utilizing the classification rules 18.

FIG. 14 is a diagrammatic illustration of the communication of the VNIC packets 114, from a VNIC client application 100, for contribution to an information profile 108. The information profile 108 in turn constitutes input to the classification rules 18 utilized by the virtual machine 10 to implement a policy-based network traffic management scheme.

In one embodiment, a keep-alive transaction between an active user's account and the network connection device 12 establishes an association between a MAC address of a workstation 102, for example, being used by the user, and an information profile 108. The classification rules 18 (and other policy rules) illustrated in FIG. 14, now have access to additional criteria included within information profile 108 when making policy decisions.

In one embodiment, information profiles 108 are not configured into a network connection device 12, as this would result in an administrative burden, increase the cost of the network connection device 12, and require the network connection device 12 to scale to the size of a user community rather than I/O bandwidth. In one embodiment, a VNIC protocol communicates an information profile 108 to the network connection device 12, for utilization by the classification rules 18, during a keep-alive transaction.

In one embodiment, the information profile 108 may be derived from a registry of a workstation 102 (or PC), and can include workgroup information, application information, and user acknowledgments.

An exemplary use scenario of the VNIC client application 100, and a VNIC protocol to communicate information profiles 108 to a network connection device 12, will now be described. In the exemplary use scenario, a network administrator wishes to partition bandwidth of a Wide Area Network (WAN) into three communities, namely gold, silver and bronze communities. The bronze community is a default community to which all users belong, while the gold and silver communities have explicit membership. The deployment of this partitioning, in one exemplary embodiment, includes three steps, namely: (1) providing wide area connectivity, (2) providing packet classification, and (3) deploying the VNIC client application and profile.

Dealing with the first step of providing wide area connectivity, in the exemplary embodiment three separate circuits are established across the WAN for each of the communities. Table 3 below provides details of these circuits:

TABLE 3

| Community | VCC | B/W |
|---|---|---|
| bronze | 10 | 32 Kb/s |
| silver | 20 | 128 Kb/s |
| gold | 30 | 256 Kb/s |

It will be noted that the separate circuits may be static channels using permanent virtual circuits or dynamic channels utilizing some combination of signaling (e.g., label distribution or call set-up).

Moving on now to the second step of providing packet classification, a classification rule 18 is introduced to the network connection device 12 for utilization by a virtual machine 10, the classification rule 18 specifying a classification of packets according to a community membership of a sender. An exemplary rule definition is provided immediately below.

| | |
|---|---|
| RULE BwPartition | // the name of the rule |

| | |
|---|---|
| PROCESS DATA_PLANE(LABEL) | // rule is for the label hook of the data plane |

| | |
|---|---|
| USES Packet_Revision_1 | // rule is written assuming packet revision 1 |

| | |
|---|---|
| INTEGER GOLD = 1 | // the gold community |
| INTEGER SILVER = 2 | // the silver community |
| INTEGER BRONZE = 3 | // the bronze community |
| INTEGER GOLD_VCC = 30 | // the gold channel |
| INTEGER SILVER_VCC = 20 | // the silver channel |
| INTEGER BRONZE_VCC = 10 | // the bronze channel |

BEGIN

| | |
|---|---|
| COMPONENT SIGS | // use the sig switch op-code set |

IF

| | |
|---|---|
| UserProfileIsKnown | // is a V-NIC session active for this packet? |

THEN

IF

| | |
|---|---|
| UserCommunityIs(GOLD) | // If the user in the gold community |

| | |
|---|---|
| THEN SetTxLabelI(GOLD_VCC) | // then use the gold VCC, else |
| ELSE | |

IF

| | |
|---|---|
| UserCommunityIs(SILVER) | // If the user in the silver community |

| | |
|---|---|
| THEN SetTxLabelI(SILVER_VCC) | // then use the silver VCC, else |

ELSE

IF

| | |
|---|---|
| UserCommunityIs(BRONZE) | // If the user in the bronze community |

| | |
|---|---|
| THEN SetTxLabelI(BRONZE_VCC) | // then use the bronze VCC, else |

| | |
|---|---|
| ELSE DISCARD | // it's an invalid profile! |

ELSE

| | |
|---|---|
| SetTxLabelI(BRONZE_VCC) | // If the V-NIC is not running then default |

| | |
|---|---|
| END | // to the bronze community |

As will be noted from the above classification rule 18, the rule 18 is declared as being part of a process DATA_PLANE, and is targeted for a hook point LABEL. This is the part of data plane is responsible for determining the correct transmission label to be used for outgoing flows. The rule 18 defines three integer constants, each representing a respective community, and three integer constants for each corresponding VCC. When a packet 29 arrives and the LABEL rule is invoked, the rule 18 first calls the predicate “USERPROFILEISKNOWN”. This operation succeeds if there is a current VNIC session for the relevant flow calls, otherwise it fails. If no VNIC session is active, then the packet 29 is labeled with the default of the “bronze” VCC. If a VNIC session is active however, the classification rule 18 systematically checks the community attribute of a relative information profile 108 to determine the community to which the profile belongs. If the relative attribute is located, the transmit label is set to a corresponding VCC. If the community identifier is not valid, then the relevant packet 29 is simply discarded because this implies a badly configured information profile 108.

The third step in the exemplary user scenario is the deployment of the VNIC client application 100. Specifically, for each workstation 102 participating in the partitioned network at the SILVER or GOLD level, an administrator must install a VNIC client application 100 (e.g., from a CD or a website containing the necessary installation uploads). The administrator further assigns each network user (or logon account) a VNIC attribute “COMMUNITY” with a community membership value of GOLD, SILVER, or BRONZE. The attribute value corresponds with the definition of gold, silver or bronze as declared in the classification rule 18 for.

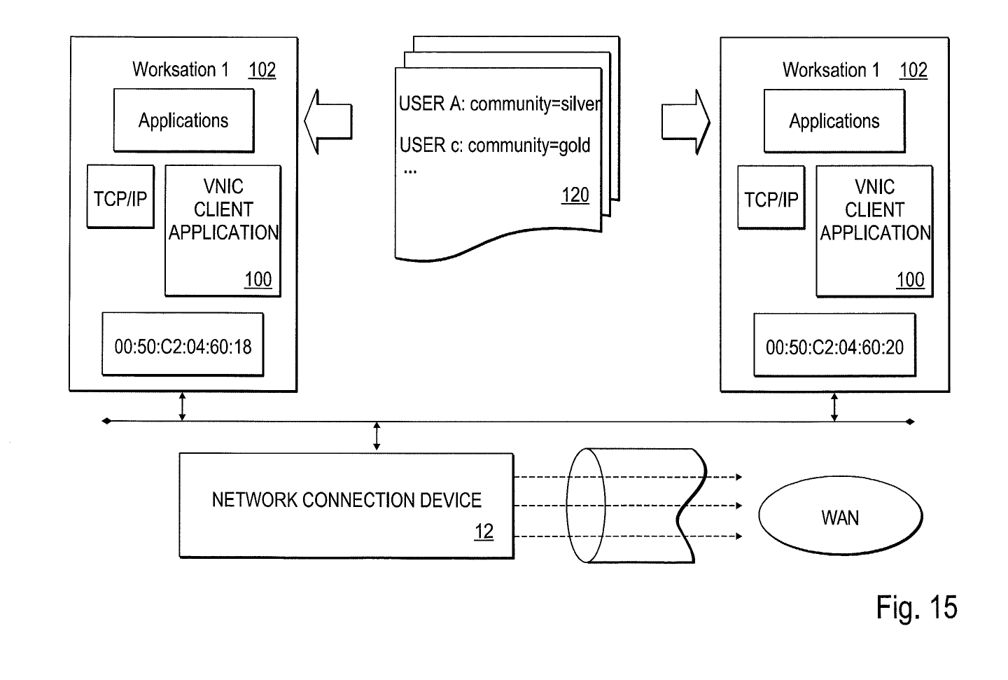

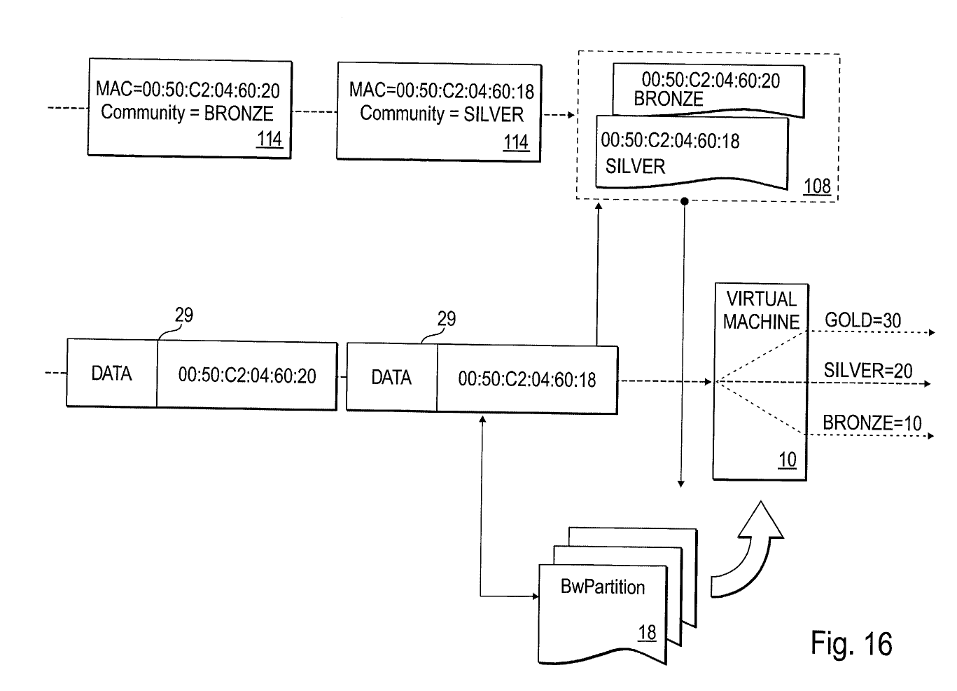

A registry 113 may be replicated (and different) in each workstation 102 or, in an alternative embodiment, may be managed from a domain server as illustrated in FIG. 15.

FIG. 16 diagrammatically illustrates the communication of VNIC packets 114, utilizing a VNIC protocol during a VNIC session, to establish and contribute to information profiles 108 utilized by a classification rule 18, in the exemplary form of a bandwidth partitioning classification rule 18. As illustrated in FIG. 16, a little connection device receives data in the form of the VNIC packets 114 from VNIC client applications 100 hosted on participating workstations 102. The VNIC packets 114 include additional information available for use during flow classification. Specifically, if an administrator assigns user A to a SILVER community, when user A logs on to a workstation 102 using an Ethernet card having a MAC address of 00:50:c2:04:60:18, the keep-alive transaction between a VNIC client application 100 executing on the relevant workstation 102 and the network connection device 12 makes an association in an information profile 108 cached by the network connection device 12 between the relevant MAC address and the SILVER community. When the network connection device 12 receives packets 12 from the relevant workstation 102, and the DATA_PLANE (LABEL) is invoked, the exemplary bandwidth partition classification rule 18, illustrated in FIG. 16, switches an outgoing flow to VCC 20.

Computer System

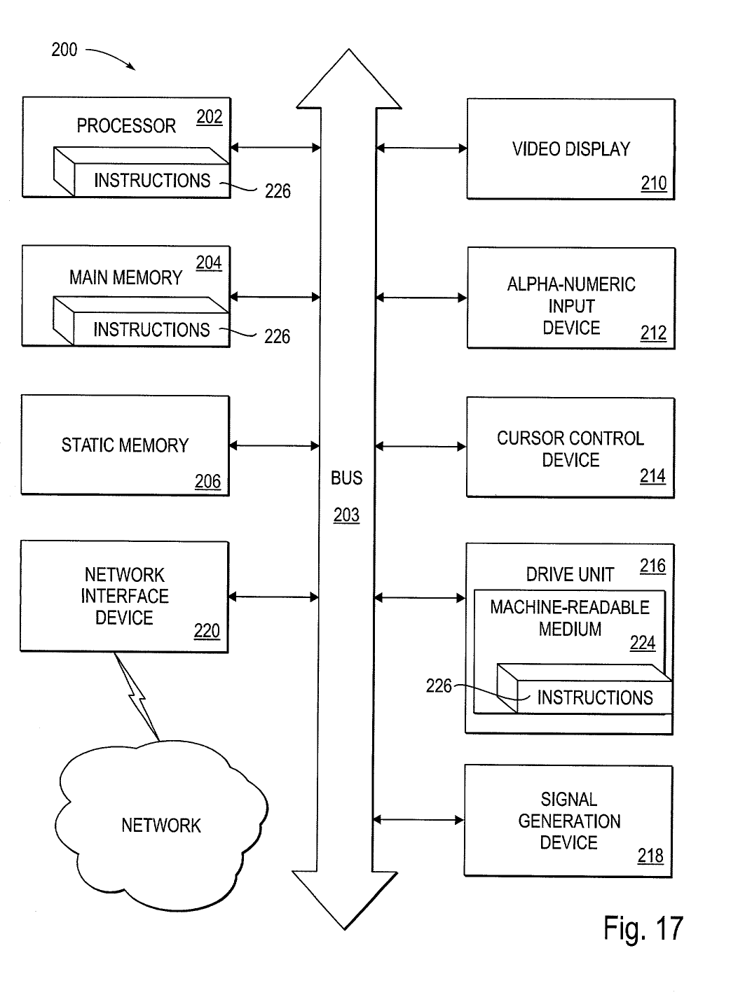

FIG. 17 is a diagrammatic representation of a machine in the exemplary form of computer system 200 within which software, in the form of a series of machine-readable instructions, for performing any one of the methods discussed above may be executed. In alternative embodiments, the machine may comprise any machine capable of executing a sequence of instructions including, but not limited to, a personal digital assistant (PDA), a mobile telephone, a network traffic device (e.g., router, bridge, switch) or handheld computing device. The computer system 200 includes a processor 202, a main memory 204 and a static memory 206, which communicate via a bus 208. The computer system 200 is further shown to include a video display unit 210 (e.g., a liquid crystal display (LCD) or a cathode ray tube (CRT)), an alphanumeric input device 212 (e.g., a keyboard), a cursor control device 214 (e.g., a mouse), a disk drive unit 216, a signal generation device 220 (e.g., a speaker) and a network interface device 222. The disk drive unit 216 accommodates a machine-readable medium 224 on which software 226 embodying any one of the methods described above is stored. The software 226 is shown to also reside, completely or at least partially, within the main memory 204 and/or within the processor 202. The software 226 may furthermore be transmitted or received by the network interface device 222. For the purposes of the present specification, the term “machine-readable medium” shall be taken to include any medium that is capable of storing or encoding a sequence of instructions for execution by a machine, such as the computer system 200, and that causes the machine to perform the methods described above. The term “machine-readable medium” shall be taken to include, but not be limited to, solid-state memories, optical and magnetic disks, and carrier wave signals.

If written in a programming language conforming to a recognized standard, the software 226 can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine, such as the computer system 200, the machine to perform an action or a produce a result.

Thus, a method and system to implement policy-based network traffic management have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to implement policy-based network traffic management, the method including:
receiving first data pertaining to a network device at a network traffic manager, the first data being received out-of-band of network traffic;
extracting second data from the network traffic; and
implementing a network traffic management policy at the network traffic manager utilizing the first and second data.

2. The method of claim 1 wherein the first data is associated with the network traffic by being communicated to the network traffic manager out-of-band during a keep-alive session pertaining to the network traffic.

3. The method of claim 1 wherein the first data comprises data concerning network access rights of a user of the network device.

4. The method of claim 3 wherein the network access rights are specified as a bandwidth allocation.

5. The method of claim 4 wherein the bandwidth allocation is expressed in terms of a community membership.

6. The method of claim 1 wherein the first data comprises data concerning network access requirements of the network device.

7. The method of claim 6 wherein the network access requirements are of an application executing on the network device.

8. The method of claim 1 wherein the first data is received from a client application executing on the network device.

9. The method of claim 8 wherein the first data includes an information profile concerning the network device.

10. The method of claim 8 wherein the first data includes network traffic conditions at the network device.

11. The method of claim 1 wherein the first data is received from a registry within which data pertaining to multiple network devices is stored.

12. The method of claim 1 wherein the first data is communicated on a periodic basis from the network device as part of a keep-alive protocol.

13. The method of claim 1 wherein the first data identifies a work group to which the network device belongs.

14. The method of claim 1 wherein the second data extracted from the network traffic is identified by a classification rule accessed by the network traffic manager.

15. The method of claim 14 wherein the second data is extracted from any one of a group of network traffic types including a packet, a cell and a frame.

16. The method of claim 14 wherein the classification rule is received at the network traffic manager from a network administrator.

17. The method of claim 1 including receiving third data pertaining to a physical characteristic of a network connection device at which the network traffic is received, and implementing the network traffic management policy utilizing the third data.

18. The method of claim 17 wherein the physical characteristic includes a port of the network connection device on which the network traffic is received.

19. The method of claim 1 including receiving fourth data pertaining to a context of receipt of the network management traffic at a network connection device, and implementing the network management policy utilizing the fourth data.

20. The method of claim 19 wherein the context includes a time of day at which the network traffic is received at the network connection device.

21. The method of claim 1 wherein the implementing of the network traffic management policy includes any one of routing, switching or bridging the network traffic.

22. The method of claim 1 wherein the implementing of the network traffic management policy includes classifying the network traffic according to at least one classification rule associated with the network management policy.

23. The method of claim 1 wherein the implementing of the network traffic manager policy includes forwarding the network traffic as one or more distinct flows.

24. The method of claim 23 wherein the distinct flows are attributed varying QoS levels, and the QoS level attributed to each distinct flow is determined according to a classification of network traffic comprising each respective discrete flow.

25. The method of claim 1 including communicating a message from the network traffic manager to an application executing on the network device from which the network traffic is received, the message including information regarding a policy decision made regarding network traffic received by the network traffic manager device.

26. A system to implement policy-based network traffic management, the system including:
a profile to receive and store first data pertaining to a network device for access by a network traffic manager, the first data being received out-of-band of network traffic;
the network traffic manager to extract second data from the network traffic and to implement a network traffic management policy utilizing the first and second data.

27. The system of claim 26 wherein the first data is associated with the network traffic by being communicated to the network traffic manager out-of-band during a keep-alive session pertaining to the network traffic.

28. The system of claim 26 wherein the first data comprises data concerning network access rights of a user of the network device.

29. The system of claim 28 wherein the network access rights are specified as a bandwidth allocation.

30. The system of claim 29 wherein the bandwidth allocation is expressed in terms of a community membership.

31. The system of claim 26 wherein the first data comprises data concerning network access requirements of the network device.

32. The system of claim 31 wherein the network access requirements are of an application executing on the network device.

33. The system of claim 26 wherein the first data is received from a client application executing on the network device.

34. The system of claim 33 wherein the first data includes an information profile concerning the network device.

35. The system of claim 33 wherein the first data includes network traffic conditions at the network device.

36. The system of claim 26 wherein the first data is received from a registry within which data pertaining to multiple network devices is stored.

37. The system of claim 26 wherein the first data is communicated on a periodic basis from the network device as part of a keep-alive protocol.

38. The system of claim 26 wherein the first data identifies a work group to which the network device belongs.

39. The system of claim 26 wherein the second data extracted from the network traffic is identified by a classification rule accessed by the network traffic manager.

40. The system of claim 39 wherein the second data is extracted from any one of a group of network traffic types including a packet, a cell and a frame.

41. The system of claim 39 wherein the classification rule is received at the network traffic manager from a network administrator.

42. The system of claim 26 wherein the network traffic manager is to receive third data pertaining to a physical characteristic of a network connection device at which the network traffic is received, and to implement the network traffic management policy utilizing the third data.

43. The system of claim 42 wherein the physical characteristic includes a port of the network connection device on which the network traffic is received.

44. The system of claim 26 wherein the network traffic manager is to receive fourth data pertaining to a context of receipt of the network management traffic at a network connection device, and to implement the network management policy utilizing the fourth data.

45. The system of claim 44 wherein the context includes a time of day at which the network traffic is received at the network connection device.

46. The system of claim 26 wherein the implementing of the network traffic management policy includes any one of routing, switching or bridging the network traffic.

47. The system of claim 26 wherein the network traffic manager is to classify the network traffic according to at least one classification rule associated with the network management policy.

48. The system of claim 26 wherein the network traffic manager is to forward the network traffic as one or more distinct flows.

49. The system of claim 48 wherein the network traffic manager is an attribute varying QoS levels to the distinct flows, and the QoS level attributed to each distinct flow by the network traffic manager is determined according to a classification of network traffic comprising each respective discrete flow.

50. The system of claim 26 wherein the network traffic manager is to communicate a message to an application executing on the network device from which the network traffic is received, the message including information regarding a policy decision made regarding network traffic received by the network traffic manager device.

51. A system to implement policy-based network traffic management, the system including:
first means for receiving and storing first data pertaining to a network device, the first data being received out-of-band of network traffic;
second means for extracting second data from the network traffic and for implementing a network traffic management policy utilizing the first and second data.

52. The machine-readable medium storing a sequence of instructions that, when executed by a machine, cause the machine to perform a method for implementing policy-based network traffic management, the method including:
receiving first data pertaining to a network device at a network traffic manager, the first data being received out-of-band of network traffic;
extracting second data from the network traffic; and
implementing a network traffic management policy at the network traffic manager utilizing the first and second data.
